(19) United States
(12) Patent Application Publication
(10) Pub. No.: US 2004/0228946 A1
(43) Pub. Date: Nov. 18, 2004

(54) Inline screw plasticizing injection apparatus

(75) Inventors: Kazuhisa Yokoyama, Hiroshima-shi (JP); Hideaki Nakashima, Hiroshima-shi (JP); Fumiaki Tsuda, Hiroshima-shi (JP); Takahiro Tochioka, Aki-gun (JP); Mitsuharu Kaneko, Aki-gun (JP)

Correspondence Address: SUGHRUE MION, PLLC, 2100 PENNSYLVANIA AVENUE, N.W., SUITE 800, WASHINGTON, DC, 20037, US

(73) Assignees: THE JAPAN STEEL WORKS, LTD.; MAZDA MOTOR CORPORATION

(21) Appl. No.: 10/811,386

(22) Filed: Mar. 29, 2004

(30) Foreign Application Priority Data
Mar. 27, 2003 (JP) P2003-087161

(51) Int. Cl. B29C 45/48

(52) U.S. Cl. 425/587

(57) ABSTRACT

A ratio of length (L)/diameter (D) of a screw is set to 18 through 24, a length (Lf) of a supplying portion of the screw is set to 10 through 14 times the diameter (D), a groove depth (hf) of the supplying portion of the screw (14) is set to be not less than 13 mm, a groove depth (hm) of a measuring portion of the screw (14) is set to be not less than 8 mm, and a width of a molten resin path formed by a weir plate (22) and a check ring (22) in a direction orthogonal to a flow direction of the molten resin is set to be 3 through 6% of the screw diameter (D).

The present application is based on Japanese Patent Application is based on 2003-87161, which is incorporated herein by reference.

### BACKGROUND OF THE INVENTION

1. Field of the Invention

The present invention relates to an inline screw plasticizing injection apparatus having a screw having a diameter not less than 100 mm and suitable for plasticizing injection of pellets including long glass fibers, particularly relates to an inline screw plasticizing injection apparatus capable of stably and efficiently producing a large-sized injection mold product of an automobile part or the like.

2. Related Art

In a related art, when a long glass fiber reinforced resin material is molded by an ordinary plasticizing injection apparatus, fibers are broken and properties inherent to the material cannot be achieved and therefore, there is a plasticizing injection apparatus having a screw head with a reverse flow preventing ring described in JP-A-6-246802 for preventing breakage of long fibers by improving a constitution of a screw head (JP-A-6-246802).

According to the plasticizing injection apparatus disclosed in JP-A-6-246802, as shown by FIG. 5 and FIG. 6, there is formed a molten resin path 34 constituted by a hollow heating cylinder 12, a shaft 24 provided reward from a screw head 20, a weir plate 22 provided rearward from the shaft 24 and functioning as a valve seat, and a check ring 26 in a ring-like shape slidably fitted to a surrounding of the shaft 24 and capable of reciprocating between the screw head 20 and the weir plate 22 in a pace between the shaft 24 and the heating cylinder 23. The apparatus is characterized in that the molten resin path 34 reaching the screw head 20 from the weir plate 22 is not bent in an acute angle, that a ratio of a width of the molten resin path 34 in a direction orthogonal to a flow direction to a screw diameter falls in a range of 8 through 20%, that a ratio of a clearance between the weir plate 22 and the heating cylinder 22 to the screw diameter falls in a range of 4 through 10%, and that projected portions of the above-described constituent parts projected to the molten resin path 34 are rounded along the flow direction and a radius of the rounded portion is at least 0.8 mm.

Next, operation thereof will be explained.

In FIG. 5, long axis pellets 28 constituting the long glass fiber reinforced resin material supplied from a supply port 30 are supplied to a side of the screw head 20 by biting operation by a flight 32 provided at an outer periphery of a screw 14. In the meantime, the long axis pellets 28 are heated by the heating cylinder 12 to melt to plasticize and are supplied to a chamber 15 at a front end of the cylinder in a molten state by passing the molten resin path 34 partitioned by the heating cylinder 12, the weir plate 22, the check ring 26, and the screw head 20 and a notch 36 (refer to FIG. 6). Further, when a constant amount of the molten resin finishes to supply, a pressing mechanism 16 presses the screw 14 forwardly. At this occasion, the check ring 26 closes the molten resin path 34 between the weir plate 22 and the heating cylinder 12 and therefore, the molten plasticized resin does not return in a reverse direction, that is, to a side of the supply port 30. The supplied long axis pellets 28 are melted to plasticize, injected from a nozzle 18 at the front end to a molding die (not illustrated), and molded in a desired shape.

According to the plasticizing apparatus of JP-A-6-246802 in the case in which polypropylene (PP) pellets including glass fibers (GF) having a length of 12 mm are injection-molded by using an injection molding machine having a clamping force of 1470 kN and a screw diameter of 50 mm, whereas a weight-averaged fiber length of the above-described GF is 2.5 mm in an ordinary plasticizing apparatus, the weight-averaged fiber length is prolonged to 6 mm in the plasticizing apparatus of JP-A-6-246802, and in the case in which PP pellets including GF of 48 mm are injection-molded by a clamping force of 7845 kN and a screw diameter of 100 mm, whereas the weight-averaged fiber length is 4.5 mm in the ordinary plasticizing apparatus, the weight-averaged fiber length is improved to be 17 mm in the plasticizing apparatus of JP-A-6-246802, respectively, and a mold product excellent in properties inherently provided to the long glass fiber reinforced resin material, for example, strength, rigidity, impact resistance is provided.

Further, although PP pellets of a long glass fiber reinforced resin material including long GF of about 48 mm can be produced, in consideration of actual production, a bulk specific weight is reduced and therefore, the reduction in the bulk specific weight is disadvantageous in view of packing and transportation, further, also in supplying the material from the supply port to the screw, hopper bridge is brought about and normal plasticizing and measuring operation is difficult and therefore, the material is not normally used and in actual production, pellets having a GF length of about 10 through 12 mm are generally adopted as the long glass fiber reinforced resin.

Although the above-described mainly relates to the constitution of the screw head having the reverse flow preventing function, in order to restrain breakage of long glass fibers, an important factor is constituted also by a shape of the screw per se for plasticizing and melting the material while supplying the material from the material supply port.

For example, as in an apparatus described in JP-A-2-292008, it is regarded to be effective to make a groove length of the screw not less than 5 mm, or to restrain a ratio of length (L)/diameter (D) of the screw to 7 through 15 and restrain a compression ratio of the screw to be equal to or smaller than 1.8. According to the apparatus shown in JP-A-2-292008, the length (L)/diameter (D) of the screw is as small as 7 through 15 and therefore, in order to melt to plasticize the long fiber reinforced resin, a length (Lm) of a measuring portion of the screw needs to be 2 through 3 times the diameter (D), a length (Lc) of a compressing portion thereof needs to be 3 through 5 times the diameter (D) and therefore, a length (Lf) of a supplying portion becomes 2 through 7 times the diameter (D)

Here, the supplying portion (Lf) of the screw indicates a portion at a screw root (hopper side) having a deep screw groove and in forwardly transporting a molding material dropped from a hopper into the heating cylinder by rotating the screw, in order to efficiently carry out transportation of the material, the screw groove of the portion is made to be deeper than that of other portion. The compressing portion (Lc) indicates a portion at which the groove depth is gradually reduced and when the molding material passes the portion, the molding material is plasticized while being compressed and therefore, air among material particles is squeezed out and necessary pressure is accumulated. The measuring portion (Lm) indicates a portion at the front end portion of the screw having a constant screw groove depth and the portion is a portion necessary for transporting the plastic material uniformly plasticized by passing the compressing portion (Lc) at a constant speed. Further, a ratio of a space volume of one screw of the screw groove at the supplying portion (Lf) to that of the measuring portion (Lm) is referred to as a compression ratio.

It is regarded to be effective in view of restraining breakage of fibers that a material plasticized and measured by using such a screw and restraining a screw revolution number to 20 through 50 rpm and restraining a screw back pressure to 0 through 5 MPa as less as possible is injected to fill in a die at comparative low speed of 0.2 through 1.0 m/min.

Meanwhile, in recent years, in molding a large-sized part for an automobile of a base material for a front end module, a door panel, a rear hatch back door module or the like, a size of a die is increased, a large-sized machine having a clamping force not less than 9806 kN is needed and a screw having a diameter not less than 100 mm is adopted. Further, in molding by the large-sized machine having a screw diameter not less than 100 mm, in the case of a long glass fiber reinforced resin using polypropylene having low fluidity and low viscosity, an increase in shear stress accompanied by large aperture formation of the screw diameter amounts to significant breakage of glass fibers and it is difficult to provide a molded product excellent in strength, rigidity, and impact resistance.

Hence, it has been found as in an apparatus shown in JP-A-2002-220538 that by using a polypropylene resin having a high fluidity in which a melt flow rate (MFR) falls in a range of 100 through 300 g/10 min as a matrix polymer of a long glass fiber reinforced thermoplastic resin, shear stress applied on glass fibers is reduced and even in a large-sized machine, breakage (cutting) of glass fibers is effectively restrained and physical properties are promoted.

Here, the melt flow rate constitutes an index of a molten viscosity of a polymer and a number of grams of a polymer injection amount per 10 minutes of a cylindrical extruded flow based on JIS K7210 (ASTEM D1238). As conditions of cylindrical extrusion, a test temperature and a test load are selected depending on respective polymers. MFR in the application is measured under conditions of a test temperature of 230° C. and a test load of 21.18 N.

Hence, in order to apply the polypropylene resin of high fluidity having such a viscosity region, there is needed a plasticizing injection apparatus comprising a screw or a screw head with a reverse flow preventing valve compatible with prevention of breakage of glass fibers and molding stability.

When the screw or the screw head of JP-A-6-246802 or JP-A-2-292008, mentioned above, is applied to a screw for a middle-sized machine having a screw diameter less than 100 mm, molding can be carried out without particularly posing a serious problem, however, when the screw or the screw head is applied to a large-sized machine having the screw diameter not less than 100 mm, there poses a problem that a product weight is unstable and stable production cannot be carried out, a failure in outlook in accordance with a failure in dissociation of long fibers is brought about, further, a plasticizing function is low and therefore, a molding cycle is prolonged to constitute a serious drawback in actual production.

Specifically, when the plasticizing injection apparatus formed by the molten resin path as shown by JP-A-6-246802 is going to be applied to a large-sized machine having a screw of a large aperture having a screw diameter not less than 100 mm, a path width B (that is, seal stroke) in the direction orthogonal to the flow direction of the molten resin path formed by the weir plate 22 and the check ring 26 (refer to FIG. 4) is 8 through 20% of the screw diameter and therefore, for example, the path width B becomes 8 through 20 mm for the screw diameter of 100 mm, the path width B becomes 10.4 mm through 26 mm for the screw diameter of 130 mm and the path width B becomes 12.8 through 32 mm for the screw diameter of 160 mm. When the molten resin path having such a wide path width B is adopted, an amount of resin flowing back from the chamber 15 to the side of the screw 14 until the check ring 26 and the weir plate 22 are closed in starting injection is increased and also a seal timing is not made to be constant by being delicately influenced by the viscosity of the molten resin or the like. As a result, it has been found that there is brought about a drawback that burrs and short shots are liable to be produced and stable production cannot be carried out, which constitutes a serious hindrance in reduction to practice.

Particularly, there has remarkably been recognized a phenomenon that a mold weight is difficult to stabilize in a long glass fiber reinforced resin material using a polypropylene resin having a high fluidity in which the metal flow rate falls in a range of 100 through 300 g/10 min as a matrix polymer, mentioned later, effective in molding by a large-sized machine.

Meanwhile, according to an inline screw plasticizing injection machine of JP-A-2-292008, the plasticized and melted material which is measured and accumulated in the chamber is injected and therefore, the screw is retracted by an amount of a predetermined measuring stroke. Since a value (S/D) constituted by dividing a retraction stroke (S) by a screw diameter (D) normally falls in a range of 2 through 5 and therefore, in the case of a screw having a length (Lf) of the supplying portion equal to 2 through 7 times the diameter (D), an effective (Lf) of the supplying portion is reduced in accordance with retraction of the screw and a function of supplying the material is lowered and therefore, the following problem is posed.

That is, when the length (Lf) of the supplying portion of the screw is short, there poses a problem that a function of transporting the material is deteriorated, a measuring time period is prolonged and unstable (so-to-speak surging phenomenon), the productivity is deteriorated and stable molding is difficult. Further, when the supplying portion (Lf) is short, in a state in which an amount of heat added from an outside heater to a pellet material become deficient and preheating is insufficient, the pellet material undergoes a high shear force in a compressing zone and therefore, there poses a problem that long glass fibers are liable to be broken, melting thereof becomes insufficient and there is brought about a failure in outlook accompanied by a failure in dissociation of bundled long glass fibers and in an extreme case, unmelted resin is mixed to a mold product to thereby deteriorate physical properties.

Although it is conceivable to increase the screw back pressure or increase the screw revolution number in order to resolve such a drawback, as described also in JP-A-2-292008, breakage of long glass fibers is increased and therefore, in the case of a screw having small (L/D), there poses a problem that there is a limit in dealing therewith by the molding conditions of the screw back pressure, the screw revolution number and the like.

### SUMMARY OF THE INVENTION

The invention has been carried out in order to resolve the above-described problem and it is an object thereof to provide an inline screw plasticizing injection apparatus capable of stably and efficiently producing a large-sized injection-molded product of an automobile part or the like comprising a long glass fiber reinforced resin material by restraining breakage of long glass fibers and improving seal function of a check ring in an injection step by stabilizing a plasticizing function and constituting a shape of the check ring and a molten resin path by proper ranges by constituting a specification (L/D, a length of a supplying portion, a groove depth and the like) of a screw having a large aperture (particularly, a screw diameter not less than 100 mm) by values optimum for the long glass fiber reinforced resin.

Further, it is an object of the invention to naturally enable to mold a long glass fiber reinforced resin material on sale by effectively achieving various properties provided thereby and further promote physical properties and achieve a high degree of stable molding performance in a long glass fiber reinforced resin using PP resin having a high fluidity in which a metal flow rate falls in a range of 100 through 300 g/10 min as a matrix polymer developed for a large-sized part of an automobile.

The invention is characterized in an inline screw plasticizing injection apparatus including a screw (14) having a diameter not less than 100 mm, forming a molten resin path constituted by a hollow heating cylinder (12), a shaft (24) provided on a rear side of a screw head (20), a weir plate (22) provided on a rear side of the shaft (24), and a check ring (26) in a ring-like shape slidably fitted to a surrounding of the shaft (24) and capable of reciprocating between the screw head (20) and the weir plate (24) in a space between the shaft (24) and the heating cylinder for plasticizing and injecting a thermoplastic resin pellet including long glass fibers having a length substantially the same as a length of the pellet and aligned in a longitudinal direction of the pellet, wherein a ratio of a length (L)/a diameter (D) of the screw is set to 18 through 24, a length (Lf) of a supplying portion of the screw (14) is set to 10 through 14 times the diameter (D), a groove depth (hf) of the supplying portion of the screw is set to be not less than 13 mm, a groove depth (hm) of a measuring portion of the screw (14) is set to be not less than 8 mm, and a width in a direction orthogonal to a flow direction of the molten resin in the molten resin path formed by the weir plate (22) and the check ring (26) is set to 3 through 6% of the diameter (D) of the screw.

The invention is further characterized in that an angle of θ between end faces of the weir plate (22) and the check ring (26) and a vertical axis is set to 70 through 90° in the inline screw plasticizing injection apparatus.

The invention is further characterized in being constituted such that a projection (26′) provided on a front side of the check ring is fitted to a notch (36) of the screw head and in rotating the screw (14), the check ring (26) is rotated along therewith in the inline screw plasticizing injection apparatus.

The invention is further characterized in that a width of the check ring (26) is set to 0.3 through 0.4 times the diameter (D) of the screw in the inline type plasticizing injection apparatus.

The invention is further characterized in that a matrix polymer of the long glass fiber reinforced thermosetting resin is constituted by a polypropylene resin having a high fluidity in which a melt flow rate thereof falls in a range of 100 through 300 g/10 min in the inline screw plasticizing apparatus.

Further, the notations in parentheses designate corresponding members of a mode for carrying out the invention, mentioned later.

### BRIEF DESCRIPTION OF THE DRAWINGS

FIG. 1 is a partially sectional view of an inline screw plasticizing injection apparatus showing a mode for carrying out the invention;

FIG. 2 is a side view of a screw of the inline screw plasticizing injection apparatus showing a mode for carrying out the invention;

FIG. 3 is a view enlarging a front end portion of the screw having a corotation type check ring of the inline screw plasticizing injection apparatus showing the mode for carrying out the invention;

FIG. 4 is a view enlarging a front end portion of a screw having a non-corotation type check ring of an inline screw plasticizing injection apparatus of a related art;

FIG. 5 is an outline sectional view of the inline screw plasticizing injection apparatus of the related art; and

FIG. 6 is a view enlarging an essential portion of the plasticizing injection apparatus of FIG. 5.

### DETAILED DESCRIPTION OF THE PREFERRED EMBODIMENTS

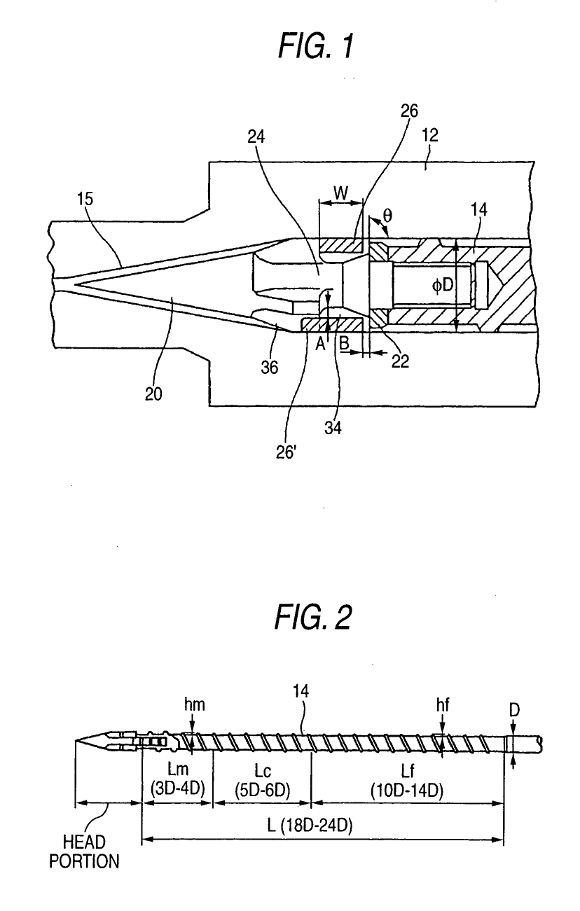

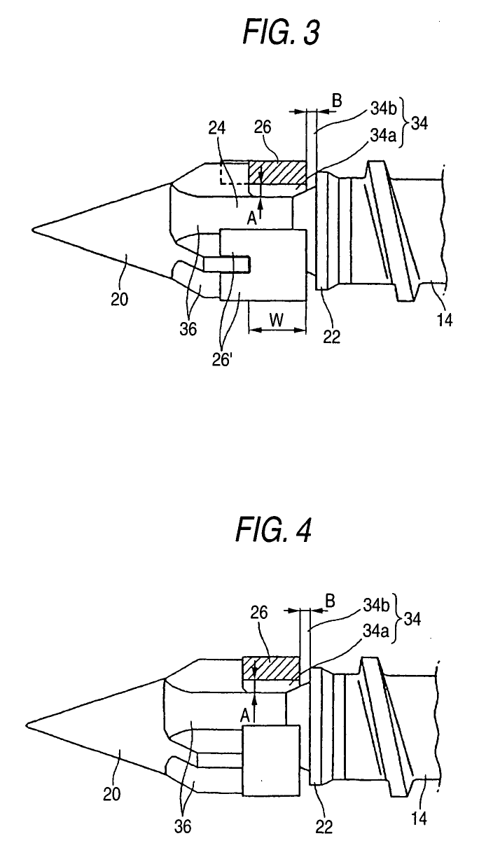

An explanation will be given of an inline screw plasticizing injection apparatus of a mode for carrying out the invention in reference to the drawings. FIG. 1 is a partially sectional view of an inline screw plasticizing injection apparatus showing a mode for carrying out the invention of the application, FIG. 2 is a side view of a screw of the inline screw plasticizing injection apparatus, and FIG. 3 is a view enlarging a front end portion of a screw having a corotation type check ring.

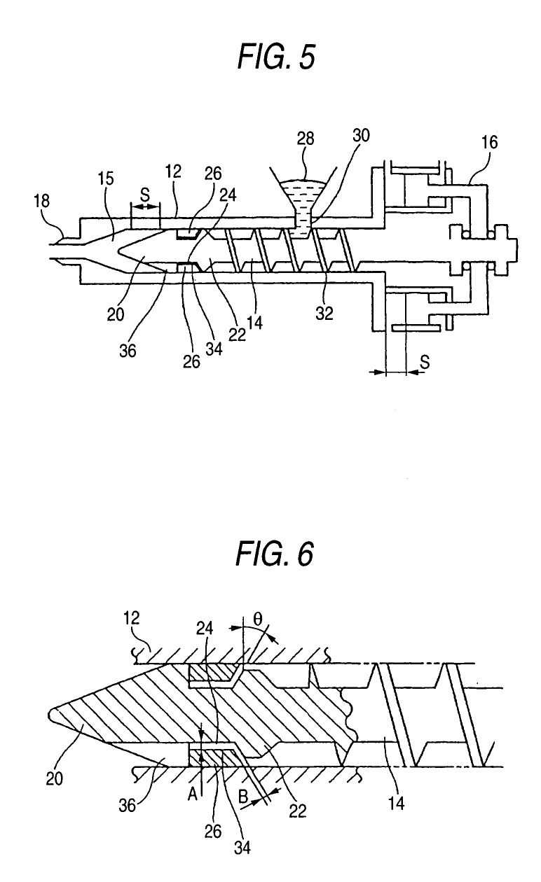

Further, a basic constitution of the inline screw plasticizing injection apparatus is similar to the inline screw plasticizing injection apparatus of JP-A-6-246802 shown in FIG. 5 and therefore, a portion having similar constitution and operation is attached with the same notation.

An explanation will be given of a mode for carrying out the invention in reference to the drawings as follows.

As shown by FIG. 5, the inline screw plasticizing injection apparatus for long axis pellets is basically constituted by the heating cylinder 12, the screw 14 capable of rotating and capable of reciprocating at inside of the heating cylinder 12, the nozzle 18 of the heating cylinder 12 for injecting a thermoplastic resin melted and plasticized between the heating cylinder 12 and the screw 14 to a die, not illustrated, and the screw rotating and pressing mechanism 16 provided on a side opposed to the nozzle 18 provided on the front side. The head portion of the screw 14 is provided with the screw head 20 in a conical shape having a plurality of the notches 36 (only a portion thereof is shown in FIG. 5) constituting the molten resin path 34 of the head portion. The weir plate 22 functioning as the valve seat is provided on a rear side thereof (a side opposed to the nozzle 18), and the check ring 26 in the ring-like shape capable of reciprocating between the screw head 20 and the weir plate 22 is slidably fitted to the surrounding of the shaft 24 between the screw head 20 and the weir plate 22. The upper portion of the heating cylinder 12 is provided with the pellet supply port 30 for charging the long-axis pellets 28 constituting the long glass fiber reinforced resin material.

First, an explanation will be given of a characteristic of the screw head portion of the mode for carrying out the invention. In the molten resin path 34 formed in JP-A-6-246802, according to the mode for carrying out the invention, as shown by FIG. 1, by restraining the ratio of the path width B in the direction orthogonal to the flow direction of the resin path to the screw diameter (D) to 3 through 6% and constituting an angle θ between the end faces of the check ring 26 and the weir plate 22 and a vertical axis by 70 through 90°, the seal function in injection can be promoted while restraining various properties provided by a long fiber resin mixture to plastically required levels as mentioned later.

The angle θ between the end faces of the weir plate 22 and the check ring 26 and the vertical axis is constituted by 70 through 90° because when the angle θ is equal to or smaller than 60°, in comparison with the angle of 70 through 90°, the molten resin is liable to flow and therefore, there is a drawback that the molten resin is liable to flow back from the side of the chamber 15 to the side of the screw 14 by passing the resin flow path 34 during a time period until the check ring 26 is closed in starting injection and in order to improve the drawback, it is necessary to reduce the path width B to be equal to or smaller than 3% of the screw diameter (D) to thereby increase breakage of glass fibers. Therefore, by increasing a flow resistance thereof from the side of the chamber 15 to the side of the screw 15 by constituting the angle θ between the end faces of the weir plate 22 and the check ring 26 and the vertical axis to be 70 through 90°, the flow back amount during the time period until closing the path width B by bringing the check ring 26 into contact with the weir plate 22 can be reduced and the molding stability can be promoted.

Further, the path width B in the direction orthogonal to the flow direction of the molten resin path is constituted by 3 through 6% of the screw diameter. For example, in the case of the screw diameter of 100 mm, the path width B becomes 3 through 6 mm, in the case of the screw diameter of 130 mm, the flow path (B) becomes 3.9 through 7.8 mm, and in the case of the screw diameter of 160 mm, the path width B becomes 4.8 through 9.5 mm. By constituting such a range, a variation in an injected weight produced by retarding a seal timing in starting injection can be prevented while restraining breakage of glass fibers to constitute a practically excellent remaining fiber length. Here, with regard to “seal timing”, in plasticizing and measuring the material, the check ring 26 is pressed to the side of the screw head 20 and the molten material is supplied to the chamber 15 on the front side by passing the resin flow path 34 and a predetermined amount thereof is measured. Thereafter, the molten material is injected at a succeeding cycle and a time lag until the resin flow path (B) is completely closed from starting injection is referred to as the seal timing. The larger the path width B, the more varied is the seal timing by a delicate change in a resin temperature (molten viscosity) or the like and therefore, the pertinent path width B is needed for stable molding. For example, although according to the plasticizing apparatus for long fibers of JP-A-6-246802, the path width B in the direction orthogonal to the flow direction of the molten resin path is constituted by 8 through 20% of the screw diameter, in the case of a screw having a large aperture of a diameter not less than 100 mm, the path width B of 3 through 6% is pertinent. That is, when the ratio of the path width B of the resin path exceeds 6%, the variation in the seal timing is liable to be brought about and therefore, there is brought about a drawback that short shots and burrs are produced and stable molding becomes difficult. Because on the contrary, when the path width B is less than 3%, since the path width B is excessively narrow, there is brought about a drawback that the measuring time period is prolonged, the productivity is deteriorated and breakage of glass fiber is increased and predetermined physical properties cannot be achieved.

Meanwhile, in types of the check ring, in gross classification, although there are two kinds of a type (non-corotation type) in which the check ring is not rotated in rotating the screw and a type (corotation type) in which the check ring is rotated along with the screw in rotating the screw, according to the invention, as shown by FIG. 3, there is constructed a constitution of corotation in which a front side of the check ring 26 is provided with a plurality of projections 26′ to fit to the plurality of notches 36 of the screw head 20 and in rotating the screw, the check ring 26 is rotated along with the screw head 20. Thereby, breakage of long glass fibers can be reduced by restraining to nullify a shear speed in a rotating direction applied to the resin in rotating the screw at a resin path 34b in the vertical direction having the path width B formed by the weir plate 22 and the check ring 26 and a flow path 34a in the horizontal direction having a path width (A) formed by the check ring 26 and the shaft 24 of the screw head 20. The reason of capable of nullifying the shear speed is that when the check ring 26 is constituted by a non-corotation type as shown by FIG. 4 as in JP-A-6-246802, in rotating the screw, the check ring 26 is hardly rotated and therefore, an intensified shear speed is produced between the weir plate 22 and the shaft 24 of the screw head 20 at the resin path 34b in the vertical direction and the resin path 34a in the horizontal direction. On the contrary, according to the ring of the corotation type of the invention in FIG. 3, in rotating the screw, the check ring 26 is rotated at a speed the same as that of the wear plate 22 and the screw head 20 (shaft 24) and therefore, the shear speed in the rotating direction is not produced.

Further, according to the plurality of projections 26′ fit to the plurality of notches 36 of the screw head 20, the projections 26′ of the check ring 26 are fit to all of the plurality (3 through 4 pieces) of notches of the screw head.

Further, it is also effective for restraining breakage of glass fibers at the resin flow path 34a in the horizontal direction that the width (W) of the check ring 26 excluding the projection 26′ of the check ring 26 is constituted by 0.3 through 0.4 times the screw diameter (D) in a range in which leakage of resin from an outer periphery of the check ring 26 does not hinder actual production. That is, the width (W) is constituted by 0.3 through 0.4 times the diameter (D) because when the width is smaller than 0.3 times the diameter (D), a flow back amount from a clearance between the outer periphery of the check ring 26 and the inner wall of the heating cylinder 12 is increased, an amount of advancing the screw 14 during a pressure maintaining step after finishing to charge the material is increased and when the screw 14 reaches a frontmost position, the pressure cannot be maintained, a failure of sink mark is produced and dimensional accuracy is deteriorated. On the other hand, when the width (D) is larger than 0.4, although the above-described drawback is not brought about, since the resin flow path 34a in the horizontal direction having the path width (A) is prolonged and therefore, breakage of long glass fibers tends to increase. In this way, by constituting the width (W) by 0.3 through 0.4 times 0.4D, compatibility of preventing leakage of resin from the outer periphery of the check ring 26 and breakage of fibers at the resin flow path 34a on the inner face of the check ring 26 can be achieved. By the above-described synergic effects, there can be constructed a constitution promoting the plasticizing function, promoting the seal function in injection and reducing breakage of long glass fibers.

Next, an explanation will be given of a characteristic of the screw shape of the invention. As shown by FIG. 2, the ratio (L/D) of the length to the diameter of the screw is set to 18 through 24, the length (Lf) of the supplying portion is set to 10 through 14 times the diameter (D), the length (Lc) of the compressing portion is set to 5 through 6 times the diameter (D), and the length (Lm) of the measuring portion is set to 3 through 4 times the diameter (D). According to the length (Lf) of the supplying portion, the larger the screw diameter (D), the deeper the groove depth (hf) of the supplying portion, the more difficult the preheating from the outside heater to conduct and therefore, it is effective to provide the long preheating zone by prolonging the length (Lf) of the supplying portion.

The ratio of length (L)/diameter (D) of the screw is set to 18 through 24 because when the ratio is smaller than 18, the effect of preheating the resin is reduced and therefore, the resin is insufficiently melted, a failure in outlook and an instability in strength in accordance with a failure in dissociating long fibers are brought about, further, also the plasticizing function is deteriorated and the molding cycle is prolonged. Further, in experiments, it is predicted that when the screw diameter is 160φ and length (L)/diameter (D) of the screw is 24, a sufficient effect is achieved, further, when (L/D) is increased more than necessary in design, by excessive shear operation in the screw, the glass fiber length is shortened and impact strength is lowered. Further, when (L/D) is uselessly increased, there is brought about a drawback of increasing a total length of the molding machine, the length needs to restrain to a necessary minimum and therefore, (L/D) is made to be equal to or smaller than 24.

Further, the length (Lf) of the supplying portion of the screw is set to 10 through 14 times the diameter (D) because a ratio Smax/D of a measuring stroke (Smax) to the screw diameter (D) falls in a range of 5 through 6, however, in actual molding, there is frequently a case in which a measuring stroke of ½ through ⅓ of MAX stroke is used. In any case, according to the inline screw injection machine, in order to ensure the necessary injected weight, the screw 14 is retracted and therefore, the substantial length (Lf) of the supplying portion is shortened in accordance with retraction of the screw and therefore, the function of transporting the material is gradually lowered, further, also the preheating effect from the outside heater is reduced. Even in such an inline screw, it is confirmed that when 10 through 14 times the diameter (D) is ensured as (Lf), for example, in the case in which (Lf) of the supplying portion of the screw having the screw diameter of 100 mm is 10D, in ordinary molding, the length becomes 7 through 8 times the diameter (D) and the sufficient supply function is ensured and even at MAX stroke, 4 through 5 times the diameter (D) is ensured and therefore, although the plasticizing function is more or less (10 through 20%) lowered, the extreme surging phenomenon is not brought about and the material can be plasticized. That is, in the case of the length (Lf) of the supplying portion of the screw smaller than 10D, it is confirmed that the surging phenomenon is brought about by reducing the function of supplying the material with an increase in the measuring stroke. Meanwhile, when the screw diameter (D) is increased, the groove depth (hf) of the supplying portion is deepened, the preheating effect by the outside heater at the supplying portion is deteriorated and therefore, the burden on the compressing portion (Lc) is increased, the plasticized function is lowered or the surging phenomenon is brought about and therefore, the improvement is achieved by prolonging (Lf) to 14D. On the other hand, the length (Lf) is not made to be larger than 14D because there is a drawback of increasing the total length of the molding machine, it is important to restrain the length to a necessary minimum and therefore, (Lf) is made to be equal to or smaller than 14D.

In this way, by increasing the ratio (L/D) of the length to the diameter of the screw 14 to be 18 through 24 and prolonging the length (Lf) of the supplying portion to 10 through 14 times the diameter (D), the sufficient heat amount can be provided to low material pellets, the material is transported to the compressing portion in a state of being easy to soften and melt and therefore, the shearing force is lowered and breakage effected to the bundled glass fibers can be restrained to reduce. Further, since the length (Lf) of the supplying portion is as large as 10 though 14 times the diameter (D), even when the screw 14 is retracted by an amount of 2 through 5 times the diameter (D) as the measuring stroke (S) for measuring the molten material in the chamber 15 at the front end of the cylinder, the effective length (Lf) of the supplying portion of the screw 14 is ensured with an amount of 8 through 9 times the diameter (D) and therefore, stable measuring operation can be carried out even at low speed rotation.

It is effective that with regard to the groove depth of the screw 14, that the groove depth (hf) of the supply portion is made to be larger than the pellet length (ordinarily, about 10 through 12 mm) and made to be not less than 13 mm for preventing breakage of the material in biting the material from the material port to the screw 14 and with regard to the groove depth (hm) of the measuring portion, the groove depth (hm) is made to be not less than 8 mm in order to prevent nondissociation of glass fibers and restrain breakage of glass fibers as less as possible. With regard to the groove depth of the screw, the screw depth is made to be not less than 13 mm at the supplying portion (hf) and made to be not less than 8 mm at the measuring portion (hm). The groove depth (hf) of the screw supplying portion is made to be not less than 13 mm and the groove depth of the measuring portion is made to be not less than 8 mm by the following reason. Although the pellet length in the long fiber resin mixture can be changed in the range of 6 through 24 mm in accordance with the object by adjusting the pellet length in producing the pellets, for use of a large-sized structural part for an automobile, pellets of 10 through 12 mm are ordinarily adopted from aimed impact strength, moldability, easiness in handling pellets or the like. In biting the pellets constituting the long glass fiber reinforced resin material from the hopper to the screw 14, when the groove depth (hf) of the supplying portion is shallower than the pellet length, in supplying the hard pellets of the screw 14, the pellets cannot smoothly be brought into the screw groove, at the time point, the pellets are cut or folded to bend and therefore, the groove length (hf) is made to be equal to larger than 13 mm deeper than the pellet length such that the breakage at the time point of bringing long glass fibers in the pellets into the screw 14 is prevented. Next, the groove depth (hm) of the measuring portion (metering) is made to be not less than 8 mm because when the groove depth (hm) is made to be smaller than 8 mm, a degree of breaking the long glass fibers is increased.

According to the invention, particularly, a large-sized structural part which is currently produced by a steel plate can be formed by the resin and therefore, considerable light-weighted formation and reduction in cost by about 20 through 25% can be achieved. Specifically, as automobile parts, the invention is applicable to various structural parts of a base material for front end module, a door panel, a door module of a rear hatch back and the like. Naturally, the invention is also applicable to a large-sized structural part other than the automobile part.

Further, the above-described modes for carrying out the invention is simply an exemplification of the invention and the invention is not limited thereto. The invention can be embodied by single ones of respective constituting requirements of the screw head or the screw or arbitrary combinations of the constituting requirements.

### EXAMPLES

Tables 1 and 2 show comparison in the plasticizing function, the weight stability, the product physical properties and the like by samples cut from PP resin products having an initial glass fiber length of 12 mm and content of glass fibers of 40% in respectives of screw diameters of 100 mm, 130 mm, 160 mm by constituting a comparative example by the inline screw plasticizing injection apparatus for long fiber fabricated based on JP-A-6-246802 and JP-A-2-292008 and constituting an embodiment by the invention. Table 1 shows specifications of the tested apparatuses and Table 2 shows the test results.

TABLE 1

| | Comparative | | Comparative | | Comparative | |
|---|---|---|---|---|---|---|
| | Example 1 | Embodiment 1 | Example 2 | Embodiment 2 | Example 3 | Embodiment 3 |
| clamping force (kN) | 9806 | 9806 | 17650 | 17660 | 25495 | 25495 |
| screw diameter D (mm) | φ100 | φ100 | φ130 | φ130 | φ160 | φ160 |
| screw L/D | 13 | 18 | 14 | 21 | 15 | 24 |
| supplying portion length Lf | 5 D | 10 D | 6 D | 12 D | 7 D | 14 D |
| screw groove depth hf/hm(mm) | 14/8 | 14/8 | 17/10 | 17/10 | 20/12 | 20/12 |
| check ring type | non-corotation | corotation | non-corotation | corotation | non-corotation | corotation |
| angle θ to vertical axis | 30° | 70° | 30° | 80° | 30° | 90° |
| path width B dimension (mm) | 10 | 4 | 15 | 5 | 20 | 8 |
| B/D × 100(%) | 10 | 4 | 11.2 | 3.8 | 12.5 | 3.8 |
| check ring width W (mm) | 70 | 40 | 80 | 50 | 90 | 60 |
| W/D ratio | 0.7 | 0.4 | 0.62 | 0.38 | 0.56 | 0.38 |

TABLE 2

| | Comparative | | Comparative | | Comparative | |
|---|---|---|---|---|---|---|
| | Example 1 | Embodiment 1 | Example 2 | Embodiment 2 | Example 3 | Embodiment 3 |
| pellet length (mm) | 12 | 12 | 12 | 12 | 12 | 12 |
| screw revolution number (rpm) | 60 | 60 | 50 | 50 | 40 | 40 |
| plasticizing formation (kg/h) | 110 | 160 | 170 | 280 | 220 | 400 |
| product weight stability¹⁾ | X | ◯ | X | ◯ | X | ◯ |
| product outlook (fiber | Δ | ◯ | Δ | ◯ | Δ | ◯ |
| dispersion)²⁾ | | | | | | |
| average fiber length of purge | 4.0 | 5.8 | 4.1 | 5.8 | 4.1 | 6.0 |
| product (mm) | | | | | | |
| Isod impact value (KJ/m2)³⁾ | 13.98/23.10 | 15.14/25.84 | 14.11/23.50 | 15.50/26.22 | 14.40/23.13 | 19.95/26.15 |
| (flow direction/vertical direction) | | | | | | |
| bending strength (MPa)⁴⁾ | 98.34/97.98 | 105.27/106.03 | 100.5/100.8 | 112.3/114.2 | 110.5/105.3 | 130.9/122.7 |
| (flow direction/vertical direction) | | | | | | |
| bending elasticity (GPa)⁴⁾ | 5.01/4.46 | 5.00/4.48 | 5.05/4.59 | 5.18/4.82 | 5.08/4.68 | 5.30/4.92 |
| (flow direction/vertical direction) | | | | | | |
| drop weight impact (all | 17.91/12.70 | 17.78/13.83 | 17.88/12.50 | 18.14/14.22 | 17.12/11.24 | 21.21/15.38 |
| absorption energy <J>⁸⁾ | | | | | | |
| (gate vicinity/flow distal end) | | | | | | |
| drop weight impact (energy up to | 6.02/6.45 | 6.91/6.58 | 6.11/6.38 | 7.03/6.84 | 5.98/6.06 | 7.56/7.44 |
| maximum load <J>⁵⁾ | | | | | | |
| (gate vicinity/flow distal end) | | | | | | |

Note
¹⁾in table ◯: excellent weight stability & stable molding possible X: mixed with short shot - burr & actual production impossible
²⁾in table ◯: usable without coating Δ: usable level by coating
³⁾test method: ASTM D256
⁴⁾test method: ASTM D790
⁵⁾test method: ISO06603-2

According to the embodiment, when the screw diameter (D) is 100 mm, the length (Lf) of the supplying portion is set to 10D, when the screw diameter (D) is 130 mm, the length (Lf) of the supplying portion is set to 12D, and when the screw diameter (D) is 160 mm, the length (Lf) of the supplying portion is set to 14D.

According to the embodiment, when the screw diameter (D) is 100 mm, the groove depth (hf) of the supplying portion is set to 14 mm and the groove depth (hm) of the measuring portion is set to 8 mm, when the screw diameter (D) is 130 mm, the groove depth (hf) of the supplying portion is set to 17 mm and the depth (hm) of the measuring portion is set to 10 mm, and when the screw diameter (D) is 160 mm, the depth (hf) of the supplying portion is set to 20 mm and the groove depth (hm) of the measuring portion is set to 12 mm.

Thereby, it is found that according to the invention, in a large-sized injection molding machine comprising the inline screw plasticizing injection apparatus having the screw diameter not less than 100 mm, by setting the ratio (L/D) of the length to diameter of the screw to 18 through 24 and setting the length (Lf) of the supplying portion to 10 through 14 times the diameter (D), the measuring time period is stabilized, the plasticizing function is improved by a multiplication factor from about 1.4 to 2 and the productivity can considerably be promoted.

By restraining the path width B in the direction orthogonal to the flow direction of the molten resin flow path 34 to 3 through 6% of the screw diameter, constituting the angle θ between the end faces of the weir plate 22 and the check ring 26 and the vertical axis to be 70 through 90°, and providing the projection 26′ on the front side of the check ring 26 to fit to the notch of the screw head 20 to thereby constitute to rotate the check ring 26 along therewith in rotating the screw, and setting the width of the check ring to 26 to 0.3 through 0.4 times the screw diameter (D), the seal function is promoted while restraining breakage of glass fibers to the practically required level and therefore, there is achieved an effect of capable of carrying out stable molding without producing a failure in molding of short shots, burrs and the like.

Particularly, in a large-sized molding product of the long glass fiber reinforced thermoplastic resin using polypropylene resin having a high fluidity in which the melt flow rate falls in the range of 100 through 300 g/10 min as the matrix polymer, the effect is remarkably recognized and it is confirmed that a stable product can be produced with a high cycle without producing short shots, burrs and the like. Further, by increasing the ratio (L/D) of the length to the diameter of the screw 14, a sufficient heat amount is provided from the outside heater to the pellet material to thereby facilitate to melt, a failure in dissociation of bundled long glass fibers is not brought about and a product having an excellent outlook can be provided.

As has been explained above, according to the invention, by constructing the constitution of setting the ratio of length (L)/diameter (D) of the screw to 18 through 24 and setting the length (Lf) of the supplying portion of the screw to 10 through 14 times the diameter (D), the sufficient heat amount can be provided from the outside heater to the raw material pellets, the material is transported to the compressing portion in the state of easy to soften and melt and therefore, the shear force is reduced, and breakage of the bundled long glass fibers can be reduced. Further, since the length (Lf) of the supplying portion is as large as 10 through 14 times the diameter (D), even when the screw is retracted by an amount of 2 through 5 times the diameter (D) as the measuring stroke (S) for measuring the molten material in the chamber at the front end of the cylinder, the effective length (Lf) of the supplying portion is ensured with an amount of 8 through 9 times the diameter (D) and therefore, stable measuring operation can be carried out even at low speed rotation.

Further, by setting the groove length (hf) of the supplying portion of the screw to be not less than 13 mm and setting the groove length (hm) of the measuring portion to be not less than 8 mm, the groove depth (hf) deeper than the pellet length is set to be not less than 13 mm and breakage of long glass fibers at the time point of bringing the pellets into the screw can be prevented and by setting the groove depth (hm) of the measuring portion to be not less than 8 mm, the resin can effectively be melted and breakage of the long glass fibers can be reduced as less as possible.

Further, by the constitution of setting the width of the molten resin path formed by the weir plate and check ring in the direction orthogonal to the flow direction of the molten resin to 3 through 6% of the screw diameter, the seal timing is not dispersed, breakage of the long glass fibers can also be reduced and therefore, the constitution is particularly effective for the screw of a large aperture having a diameter not less than 100 mm. Thereby, particularly, a large-sized automobile part can stably and efficiently be molded.

According to the invention, by the constitution of setting the angle θ between the end faces of the weir plate and the check ring and the vertical axis to 70 through 90°, the flow resistance from the side of the chamber to the side of the screw is increased and as a result, the flow back amount until closing the molten resin path (B) by bringing the check ring into contact with the weir plate is reduced and the molding stability is promoted.

According to the invention, by constructing the constitution in which the screw head having the check ring is mounted and the projection provided on the front side of the check ring is fit to the notch of the screw head to thereby rotate the check ring along with the screw in rotating the screw, the shear force in the rotating direction applied to the resin in rotating the screw at the resin path (the resin path 34b having the path width B) formed by the weir plate and the check ring and the resin path (the resin path 34a having the path width (A)) formed by the check ring and the shaft of the screw head can be restrained to nullify and therefore, breakage of the long glass fibers can be reduced.

According to the invention, by the constitution of mounting the screw head having the check ring and setting the width of the check ring to 0.3 through 0.4 times the screw diameter (D), breakage of the long glass fibers at the resin path (34a) having the path width (A) can be prevented.

According to the invention, even when the matrix polymer of the long glass fiber reinforced thermosetting resin is constituted by the polypropylene resin having the high fluidity in which the melt flow rate falls in the range of 100 through 300 g/10 min, stable product can be produced at the high cycle without producing short shots, burrs and the like.

What is claimed is:

1. An inline screw plasticizing injection apparatus which plasticizes and injects a thermoplastic resin pellet including long glass fibers having a length substantially the same as a length of the pellet and aligned in a longitudinal direction of the pellet, the injection apparatus comprising:
a screw having a diameter not less than 100 mm;
a hollow heating cylinder in which the screw is provided;
a screw head coupled to the screw through a shaft;
a weir plate fixed at an rear end of the shaft; and
a check ring slidably fitted around the shaft so as to be capable of reciprocating between the screw head and the weir plate in a space defined by the shaft and the heating cylinder so that a molten resin path is formed the by the heating cylinder, the screw head, the shaft, the check ring and the weir plate;
wherein
a ratio of a length (L)/a diameter (D) in the screw is set to 18 through 24,
a length (Lf) of a supplying portion of the screw is set to 10 through 14 times the diameter (D),
a groove depth (hf) of the supplying portion of the screw is set to be not less than 13 mm,
a groove depth (hm) of a measuring portion of the screw is set to be not less than 8 mm, and
a width in a direction orthogonal to a flow direction of the molten resin in the molten resin path formed by the weir plate and the check ring is set to 3 through 6% of the diameter (D) of the screw.

2. The inline screw plasticizing injection apparatus according to claim 1, wherein an angle of θ between end faces of the weir plate and the check ring and a vertical axis set to 70 through 90°.

3. The inline screw plasticizing injection apparatus according to claim 1, wherein a projection provided on a front side of the check ring is fitted to a notch of the screw head and in rotating the screw, the check ring is rotated along therewith.

4. The inline screw plasticizing injection apparatus according to claim 1, characterized in that a width of the check ring is set to 0.3 through 0.4 times the diameter (D) of the screw.

5. The inline screw plasticizing injection apparatus according to claim 1, characterized in that a matrix polymer of the long glass fiber reinforced thermosetting resin is constituted by a polypropylene resin having a high fluidity in which a melt flow rate thereof falls in a range of 100 through 300 g/10 min.
